(19) United States
(12) Patent Application Publication
(10) Pub. No.: US 2023/0221227 A1
(43) Pub. Date: Jul. 13, 2023

(54) FILAMENT WINDING SYSTEM AND METHOD

(71) Applicant: Technobell d.o.o., Koper (SI)

(72) Inventor: Peter Gojak, Koper (SI)

(73) Assignee: Technobell d.o.o., Koper (SI)

(21) Appl. No.: 18/149,921

(22) Filed: Jan. 4, 2023

Related U.S. Application Data
(60) Provisional application No. 63/297,362, filed on Jan. 7, 2022.

(51) Int. Cl. G01N 3/12; G01N 3/04

(52) U.S. Cl. CPC G01N 3/12; G01N 3/04

(57) ABSTRACT

A pressure testing system for a hollow component, such as a component formed by a filament winding system and method, includes an outer frame defining a base, and a support mechanism coupled to the base and having at least one movable platform for supporting the hollow component within the outer frame.

### CROSS-REFERENCE TO RELATED APPLICATION(S)

This application claims the benefit of U.S. Provisional Patent Application No. 63/297,362, filed Jan. 7, 2022, which is incorporated herein by reference in its entirety.

### BACKGROUND

Filament winding processes can be utilized to form a variety of structures including pipes, tubes, pressure vessels, tanks, casings, posts, or the like. Typical filament winding processes include coating filaments with resin, such as by passing filaments through a resin bath, resin spray/shower, or the like while under tension, and repeatedly wrapping or winding filaments over a central rotating mandrel to form a desired structure. The structure can be heat-treated or cured to harden the resin-coated filaments. In some examples, the mandrel can be removed from the structure. In other examples, the mandrel can remain with the structure to form part of the finished component.

Systems or machines utilized in filament winding can include multiple components to form the finished product or test the finished product including, but not limited to, forming the resin, coating the filaments, wrapping the filaments, cutting the produced component to a desired size, or testing a seal or fitting quality with the produced component.

### BRIEF SUMMARY

In one aspect, the disclosure relates to a pressure testing system for a hollow component having an open end. The pressure testing system includes an outer frame defining a base, a support mechanism coupled to the base and comprising at least one movable platform for supporting the hollow component within the outer frame, a fluid supply system comprising a supply tank fluidly coupled to a fluid line, and a sealing cover coupled to the outer frame and comprising an end seal for receiving the open end of the hollow component, and also comprising an aperture through which the fluid line extends, wherein the sealing cover is movable at least vertically with respect to the outer frame for alignment of the sealing cover with the open end of the hollow component.

In another aspect, the disclosure relates to a pressure testing system for a hollow sleeve and an inner sealing ring. The pressure testing system includes a platform and multiple fitting arms coupled to the platform. Each fitting arm in the multiple fitting arms includes a base assembly defining an interior and comprising a base ledge for supporting the inner sealing ring, and an arm assembly disposed at least partially within the interior. The arm assembly includes an arm with an arm ledge for supporting the inner sealing ring in registry with the hollow sleeve, and a rotatable cap pivotally coupled to the arm and defining least an open position and a closed position, wherein the rotatable cap is configured to engage a top surface of the hollow sleeve when in the closed position.

### BRIEF DESCRIPTION OF THE DRAWINGS

In the drawings:

FIG. 1 is a schematic view of an exemplary filament winding system in accordance with various aspects described herein.

FIG. 2 is a schematic perspective view of a wrapping system that can be utilized in the filament winding system of FIG. 1 in accordance with various aspects described herein.

FIG. 3 is a schematic perspective view of a cutting system that can be utilized in the filament winding system of FIG. 1.

FIG. 4 is a schematic side view of the filament winding system of FIG. 1 with a band and a set of spacers in accordance with various aspects described herein.

FIG. 5 is a perspective cutaway view of a component formed in the filament winding system of FIG. 1 in accordance with various aspects described herein.

FIG. 6 is a perspective view of a tensioner assembly that can be utilized in the filament winding system of FIG. 1 in accordance with various aspects described herein.

FIG. 7 is a bottom perspective view of the tensioner assembly of FIG. 6.

FIG. 8 is a side view of a dosing unit that can be utilized in the filament winding system of FIG. 1 in accordance with various aspects described herein.

FIG. 9 is a perspective view of a portion of the dosing unit of FIG. 8.

FIG. 10 is a perspective view of another portion of the dosing unit of FIG. 8.

FIG. 11 is a perspective view of another portion of the dosing unit of FIG. 8.

FIG. 12 is a perspective view of another portion of the dosing unit of FIG. 8.

FIG. 13 is a perspective front view of the dosing unit of FIG. 8 positioned over a mandrel.

FIG. 14 is a perspective view of a mandrel assembly that can be utilized in the filament winding system of FIG. 1 in accordance with various aspects described herein.

FIG. 15 is another perspective view of the mandrel assembly of FIG. 14.

FIG. 16 is a front view of the filament winding system 10 of FIG. 1 with the mandrel assembly of FIG. 14 and a cutting assembly in accordance with various aspects described herein.

FIG. 17 is a side perspective view of the cutting assembly of FIG. 16 illustrating a controller and a pneumatic cylinder in accordance with various aspects described herein.

FIG. 18 is a perspective view of a portion of the cutting assembly of FIG. 16.

FIG. 19 is a schematic perspective view of the cutting assembly of FIG. 16 during a cutting process.

FIG. 20 is a perspective view of a portion of a guiding assembly that can be utilized in the filament winding system of FIG. 1 in accordance with various aspects described herein.

FIG. 21 is a side perspective view of the guiding assembly of FIG. 20.

FIG. 22 is a perspective view of a portion of the guiding assembly of FIG. 20.

FIG. 23 is a perspective view of another portion of the guiding assembly of FIG. 20.

FIG. 24 is a schematic perspective view of a hydrostatic pressure testing assembly that can be utilized with the filament winding system of FIG. 1 and illustrating a sealing cover, a support mechanism, and a fluid supply system in accordance with various aspects described herein.

FIG. 25 is a schematic perspective view of the hydrostatic pressure testing assembly of FIG. 24 illustrating the sealing cover and a set of fasteners in accordance with various aspects described herein.

FIG. 26 is a partial cross-sectional view of the hydrostatic pressure testing assembly of FIG. 24 taken along line A-A of FIG. 25.

FIG. 27 is a perspective view of another support mechanism that can be utilized in the hydrostatic pressure testing assembly of FIG. 24 in accordance with various aspects described herein.

FIG. 28 is a perspective view of a sleeve hydrostatic pressure testing assembly that can be utilized with the filament winding system of FIG. 1 in accordance with various aspects described herein.

FIG. 29 is a perspective view of the sleeve hydrostatic pressure testing assembly of FIG. 28 during fitting of a hollow sleeve and a sealing ring in accordance with various aspects described herein.

### DETAILED DESCRIPTION

Aspects of the disclosure relate to a filament winding manufacturing process, systems, assemblies, and components. In some examples, filament winding processes, such as continuous filament winding (CFW) processes and discontinuous filament winding (DFW) processes, can be used to produce hollow bodies having outer diameters between 100 mm and 4000 mm. Described aspects of the present disclosure can provide for improvements in filament winding systems, processes, components, and technical solutions. The present disclosure also enables the production of composite bodies with higher capacity, lower production cost, better quality, lower risk of human error factor, wider diameter range, and faster testing procedures.

As used herein, the terms “radial” or “radially” refer to a direction away from a common center. In addition, as used herein, the term “set” or a “set” of elements can be any number of elements, including only one.

Additionally, as used herein, a “controller” or “controller module” can include a component configured or adapted to provide instruction, control, operation, or any form of communication for operable components to effect the operation thereof. A controller module can include any known processor, microcontroller, or logic device, including, but not limited to: field programmable gate arrays (FPGA), an application specific integrated circuit (ASIC), a full authority digital engine control (FADEC), a proportional controller (P), a proportional integral controller (PI), a proportional derivative controller (PD), a proportional integral derivative controller (PID controller), a hardware-accelerated logic controller (e.g. for encoding, decoding, transcoding, etc.), the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a controller module can also include a data storage component accessible by the processor, including memory, whether transient, volatile or non-transient, or non-volatile memory. Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to effect a functional or operable outcome, as described herein.

Additionally, as used herein, elements being “electrically connected,” “electrically coupled,” or “in signal communication” can include an electric transmission or signal being sent, received, or communicated to or from such connected or coupled elements. Furthermore, such electrical connections or couplings can include a wired or wireless connection, or a combination thereof.

Also, as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor as defined above, and the controller module or processor can perform processing on the value to determine a representative value or an electrical characteristic representative of said value.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Connection references (e.g., attached, coupled, connected, or joined) are to be construed broadly and can include intermediate members between a collection of elements and relative movement between elements unless otherwise indicated. As such, connection references do not necessarily infer that two elements are directly connected and in fixed relation to one another. Furthermore, as used herein, the term “set” or a “set” of elements can be any number of elements, including only one. The exemplary drawings are for purposes of illustration only and the dimensions, positions, order and relative sizes reflected in the drawings attached hereto can vary.

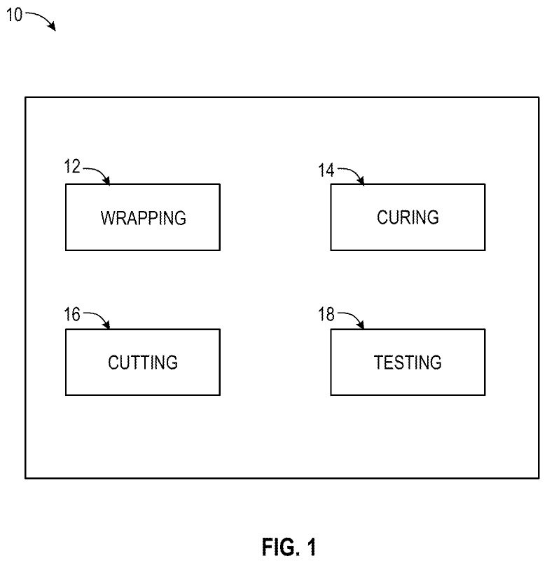

With general reference to FIGS. 1-4, portions of an exemplary filament winding system 10 are illustrated in a schematic form. The filament winding system 10 will be described as a continuous filament winding (CFW) system producing a component in the form of a hollow pipe. However, the disclosure is not so limited and aspects of the disclosure can have applicability in other filament winding systems, including discontinuous filament winding (DFW) systems, as well as forming other component types, including solid or hollow components.

The filament winding system 10 can include one or more assemblies or systems including a wrapping system 12, a curing system 14, a cutting system 16, and a testing system 18, as shown in FIG. 1. It will be understood that the filament winding system 10 can include other components, assemblies, or sub-assemblies, including tools, motors, housing portions, frames, fasteners, or the like, as is generally known in the art.

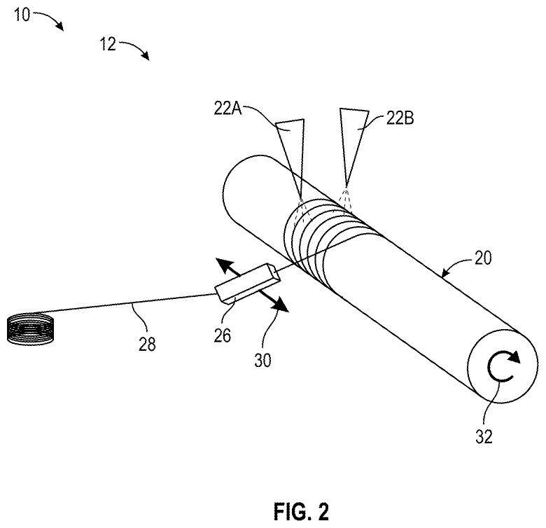

FIG. 2 illustrates the wrapping system 12 in further detail. The wrapping system 12 can include a mandrel assembly 20 (also referred to herein as “mandrel 20”), at least one supply device 22, and a filament guide 26 (also referred to herein as “guide 26”). While two supply devices 22 are illustrated, any number can be provided. Each supply device 22 can be configured to supply one or more materials onto the mandrel 20. In an example where multiple supply devices 22 are provided, the multiple supply devices 22 can supply materials onto the mandrel 20 all at once, simultaneously, or at alternating time intervals, or combinations thereof. Some non-limiting examples of materials that can provided by the supply device 22 include sand, glass, fiberglass, fibrous materials, granular materials, or resin, such as polyester resin, phenolic resin, polycarbonate resin, polyurethane resin, epoxy resin, silicone resin, or the like, or combinations thereof.

The guide 26 can provide or direct a set of filaments 28 (also known as hoop fibers) under tension onto the mandrel 20 during rotation of the mandrel 20. In some examples, the set of filaments 28 can pass through a resin coating tank prior to contacting the mandrel 20. In some examples, the set of filaments 28 can be supplied directly onto the mandrel 20 without use of a resin coating tank. The set of filaments 28 can include, in some non-limiting examples, a polymeric material, a composite material, glass, fiberglass, or carbon.

The mandrel 20 can include a metallic material, such as steel or aluminum in some examples, or a polymeric material or a composite material in some examples, or combinations thereof. The mandrel 20 can also have any suitable form, including a solid mandrel, a hollow mandrel, a unitary body, or a set of discrete members forming an overall mandrel component, in some non-limiting examples.

During operation, the set of filaments 28 can be placed under tension and the guide 26 can overlie the mandrel 20 to direct the tensioned set of filaments 28 over the mandrel 20 while the mandrel 20 is rotated. In some examples, the guide 26 can include a carriage movable at least along an axial direction 30 as indicated. It is also contemplated that the guide 26 can be stationary while the mandrel 20 is movable along the axial direction 30. The mandrel 20 can also be rotated in a direction 32 as shown. In this manner, the set of filaments 28 can be wrapped around the mandrel 20 as many times as desired.

In addition, during operation, materials such as sand, fibers, or resin can be applied, dosed, sprayed, or the like over the mandrel 20 or set of filaments 28 by the at least one supply device 22. In one non-limiting example, a first supply device 22A can deposit glass fibers while a second supply device 22B deposits heated sand, thereby coating the rotating mandrel 20 and filaments 28 with composite material. In another non-limiting example, the mandrel 20 can be wrapped with a base layer or surfacing veil (e.g. C-veil), the guide 26 can lay filaments 28 onto the mandrel 20, a first supply device can dose glass fibers onto the rotating mandrel 20 and over the set of filaments 28, a second supply device can dose sand onto the rotating mandrel 20 and over the set of filaments 28, and a third supply device can shower liquid resin onto the rotating mandrel 20 and over the set of filaments 28. In this manner, a composite component 34 can be formed by the filament winding system 10. The component 34 can be formed over the mandrel 20 with a desired thickness from the wrapped filaments 28 and any supplied materials from the at least one supply device 22.

It is further contemplated that the component 34 can be heat-treated or cured using the curing system 14 (FIG. 1), thereby hardening and strengthening the component 34. In some implementations, the mandrel 20 and component 34 can be cured together as a single unit and optionally separated after heat treatment. In some implementations, the component 34 can be removed from the mandrel 20 prior to heat treatment. In some implementations, the wrapping system 12 and the curing system 14 can be located in different spatial regions whereby the wrapped mandrel 20 can be moved from the wrapping system 12 to the curing system 14 for heat treatment. In some examples, the wrapping system 12 and the curing system 14 can be integrated into a single assembly or subassembly within the filament winding system 10.

In some examples, the mandrel 20 can be removed from the precursor component 34 whereby the wrapped, hardened set of filaments 28 can form a hollow structure with a desired thickness. In some examples, the set of filaments 28 and mandrel 20 together can form the completed structure. The mandrel 20 itself can be a hollow component or a solid component.

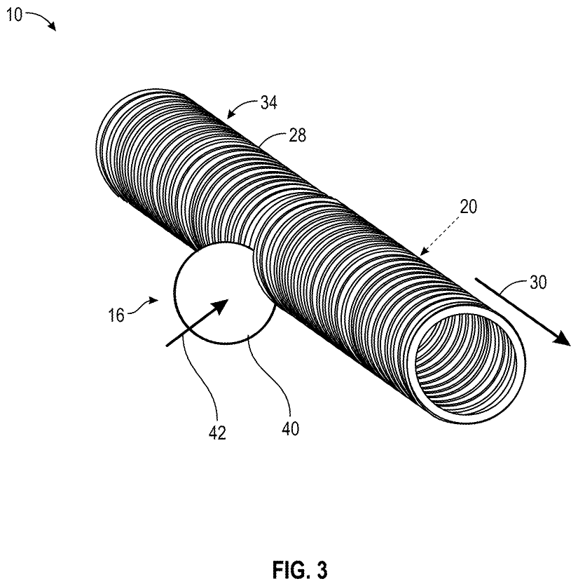

Referring now to FIG. 3, the cutting system 16 is schematically illustrated during operation. After the set of filaments 28 is hardened, in some examples the cutting system 16 can be utilized for machining or cutting the heat-treated component 34 (e.g. a heat-treated hollow pipe) to a desired length. The component 34 is schematically illustrated with discrete filaments, and it is understood that the component 34 contains a large multitude of wrapped filaments to form an overall body, wall, or the like.

The cutting system 16 can include a cutting disk 40 that can be advanced at least along a direction 42 as shown. The component 34 can be advanced along the axial direction 30 as shown. While the component 34 is moved along the axial direction, the cutting disk 40 can rotate while advancing at least along the direction 42 to cut the component 34. It is further contemplated that the cutting disk 40 can be advanced along the axial direction 30, simultaneously with the mandrel 20, while also advancing along the direction 42 to cut the component 34. In some examples, the component 34 can be simultaneously rotated, including with external rollers, while the cutting disk 40 advances into and cuts the component 34. In some examples, the cutting disk 40 can advance completely through the component 34 without additional rotation of the component 34 though this need not be the case. The cutting system 16 can, in some examples, operate to advance the component 34 along the axial direction while making periodic cuts with the cutting disk 40 to produce multiple pipes.

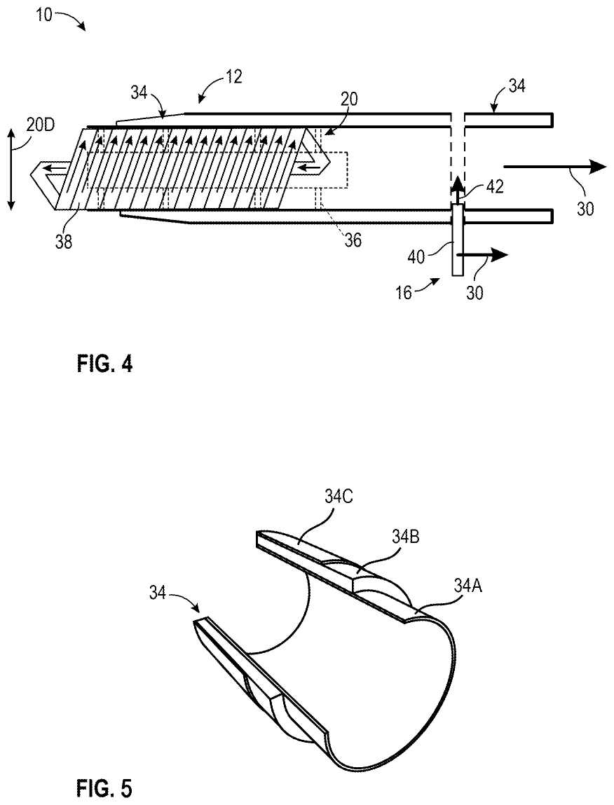

FIG. 4 schematically illustrates one exemplary implementation of the filament winding system 10 in which the mandrel 20 includes a circumferentially-arranged set of spacers 36 and a band 38 arranged or wound about the set of spacers 36. The band 38 can have a helical geometric profile. The band 38 can also be a metallic band, such as a steel band in a non-limiting example. The band 38 can form an outer surface or working surface of the mandrel 20, thereby defining an effective diameter or mandrel diameter 20D of the mandrel assembly 20. It is understood that other elements such as roller bearings, spacer beams, or the like can be provided for stability and smooth rotation of the band 38 over the set of spacers 36. In this manner, rotation of the mandrel 20 can include rotation of the band 38 over the set of spacers 36.

In some examples, the filament winding system 10 can include one or more return pushers configured to displace, shift, or remove the mandrel 20 from the hardened component or component 34. In some examples, the filament winding system 10 can continuously operate to wrap the mandrel 20 with coated filaments until a desired thickness is achieved, then cure the set of filaments 28 (e.g. by heat treatment) to harden the component 34, and then push the mandrel 20 through the hardened component 34 thereby re-exposing the mandrel 20 for repeated wrapping. Such pushing can happen in a continuous manner in some examples, whereby rotation of the band 38 and axial pushing or removal of the hardened component 34 from the band 38 is continuously performed. In other examples, removal of the hardened component 34 from the mandrel 20 can be performed over discrete time periods to re-expose the mandrel 20. Any suitable removal method is contemplated. In this manner, the filament winding system 10 can operate in a continuous manner to form an elongated, hollow, composite component 34 of any suitable length.

FIG. 5 illustrates a perspective cutaway view of the component 34 removed from the mandrel 20. It is contemplated that the finished component 34 can include multiple, discrete layers. Three layers are shown in the example of FIG. 5, and it is understood that any number of layers can be provided, including a single layer, or two or more layers.

In the non-limiting example shown, the component 34 can include a first layer 34A, such as a liner, that defines an interior surface of the component 34. A second layer 34B can overlie the first layer 34A and define a structural layer or core layer in the component 34. A third layer 34 C can overlie the second layer 34B and define an exterior surface of the component 34. In some examples, the component 34 can have two or more structural layers, such as an alternating-layer arrangement. Regardless of the number of layers in the component 34, the filament winding system 10 can be utilized to form a composite component having any desired length, thickness, or composition.

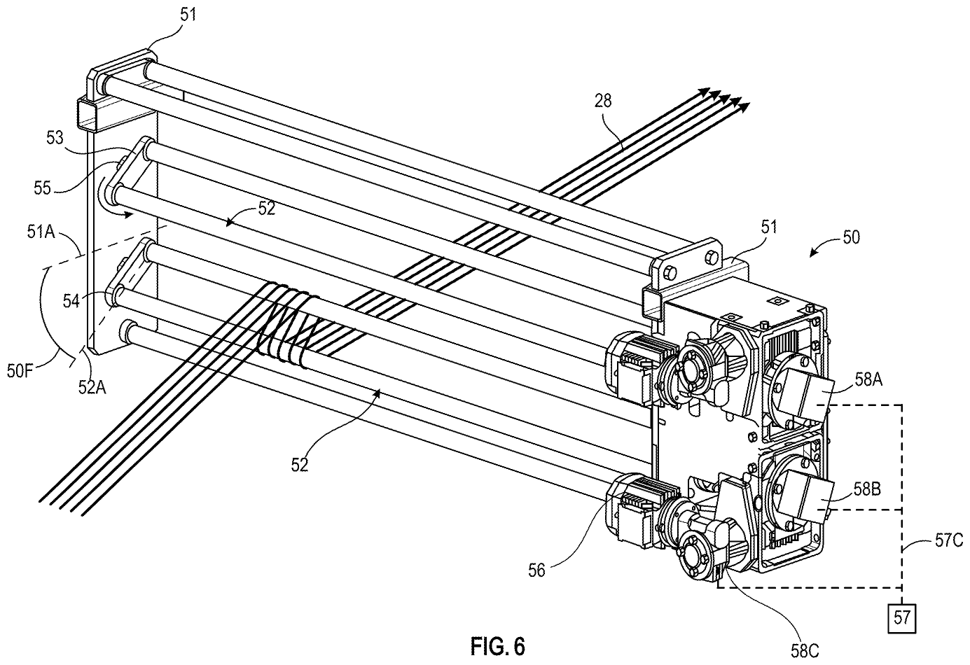

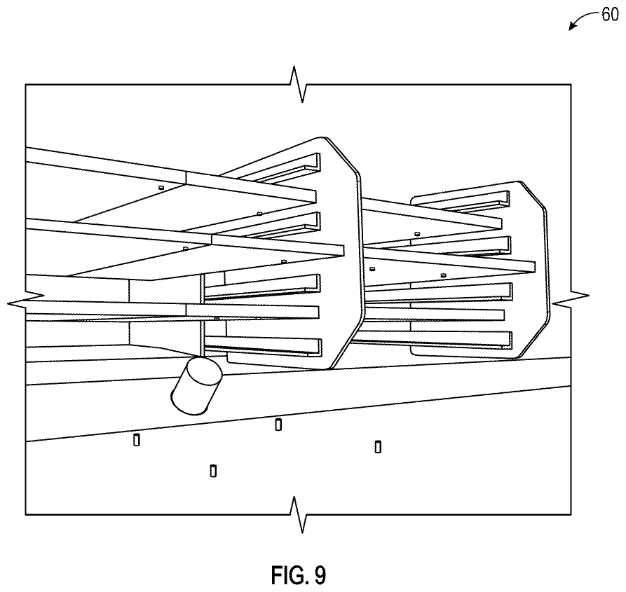

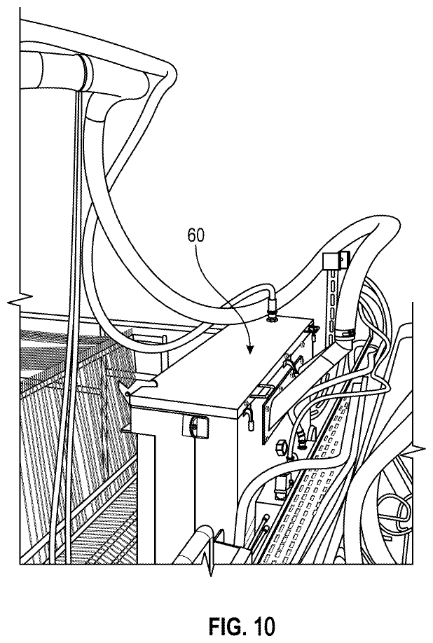

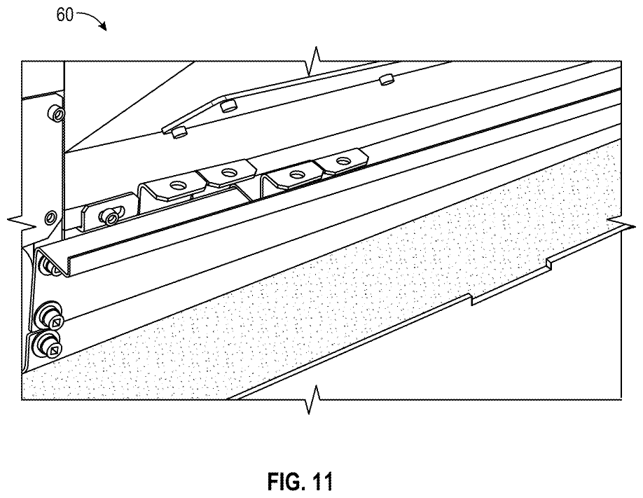

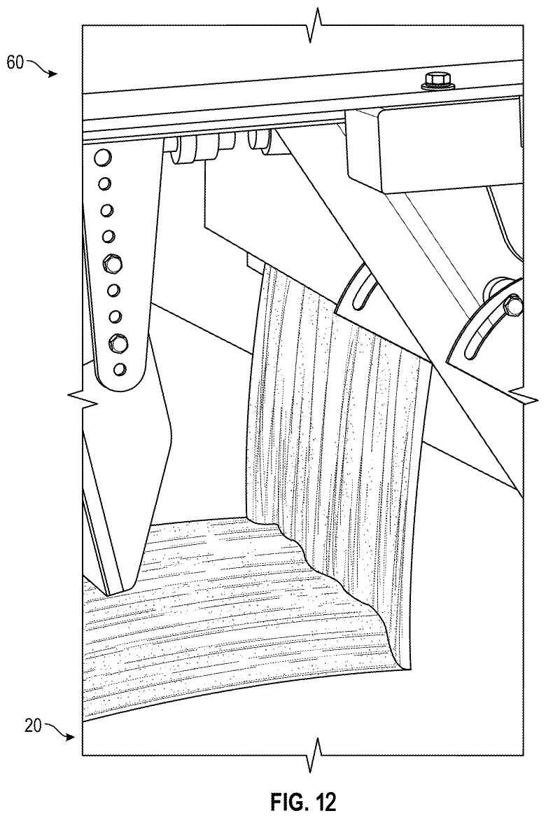

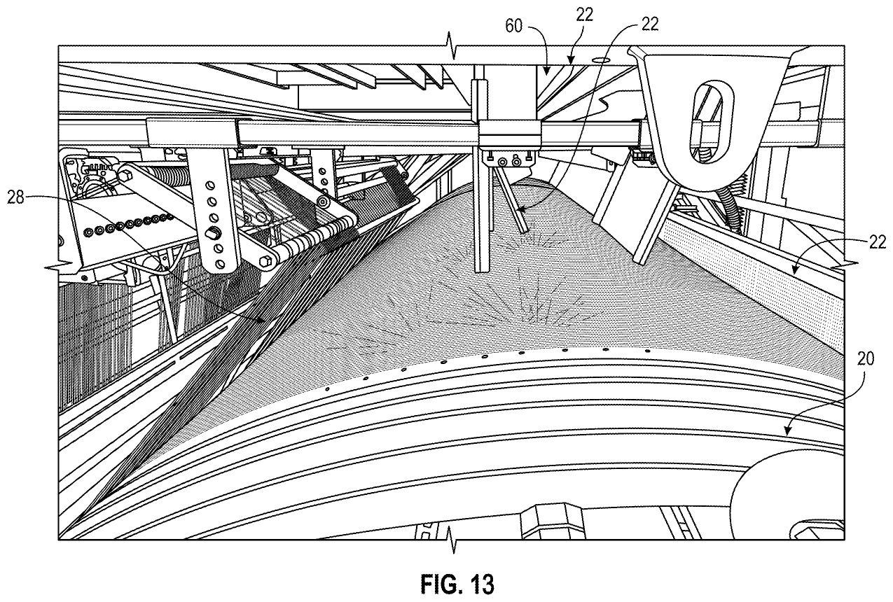

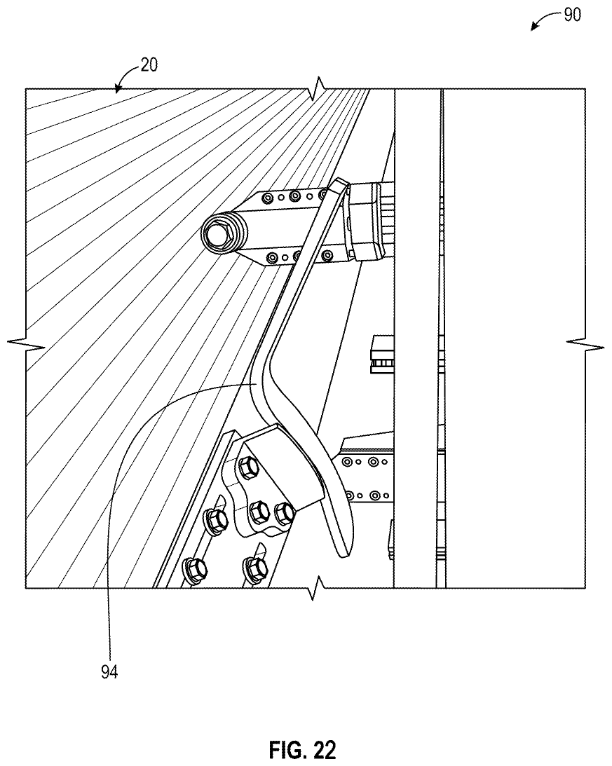

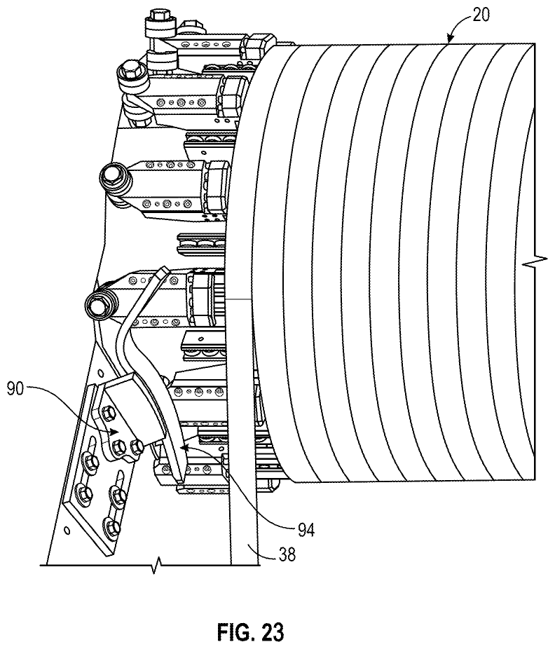

Referring generally to FIGS. 6-29, various components and assemblies are illustrated that can be utilized in the filament winding system 10. Such components or assemblies can be included in any or all of the wrapping system 12, the curing system 14, the cutting system 16, or the testing system 18 as described in FIG. 1.

Turning to FIG. 6, a tensioner assembly 50 is shown that can be utilized in the filament winding system 10, such as in the wrapping system 12. In traditional winding systems, hoop fibers or filaments are passed between manually-adjusted guides to provide tensioning of the set of filaments 28. Aspects of the disclosure provide for a system and method for automatic tension control of the set of filaments 28.

The tensioner assembly 50 can include an outer frame 51 defining a through axis 51A as shown. At least one pair of guide arms 52 can be provided in the tensioner assembly 50 through which the set of filaments 28 can be passed. The pair of guide arms 52 can define a serpentine path for the set of filaments 28. In the exemplary implementation shown, the pair of guide arms 52 are spaced apart to define a tension axis 52A as shown.

The pair of guide arms 52 can be rotatably mounted to the outer frame 51. The pair of guide arms 52 can be rotated through a full 360 degrees, or between 0-180 degrees, or between 0-90 degrees, in non-limiting examples, thereby forming a rotational position of the pair of guide arms 52 with respect to the outer frame 51. In the example shown, a bracket 53 is provided with recesses 54 receiving the pair of guide arms 52 and a rotatable mount 55 coupled to the outer frame 51. It is understood that the pair of guide arms 52 can rotate such that the tension axis 52A forms a filament tension angle 50F (also referred to herein as “filament angle 50F”) with respect to the through axis 51A. The filament angle 50F can also define the rotational position of the pair of guide arms 52.

It is further contemplated that a motor 56 can be provided in the tensioner assembly 50. The motor 56 can be operably coupled to the pair of guide arms 52. In a non-limiting example, the motor 56 can be operably coupled to the bracket 53 to rotate the pair of guide arms 52.

A controller 57 can be provided in the tensioner assembly 50. The controller 57 can have a processor and a memory. In the example shown, the controller 57 is schematically illustrated as being coupled to the outer frame 51 though this need not be the case. The controller 57 can be located at any suitable location, including being positioned remotely from the outer frame 51.

One or more sensors can also be provided in the tensioner assembly 50. In the illustrated example, a first sensor 58A, a second sensor 58B, and a third sensor 58C (this is a gearbox) are shown although any number of sensors can be provided.

The controller 57 can be communicatively coupled to any or all of the motor 56 or the sensors 58A, 58B, 58C. A communication link 57C between the controller 57, the motor 56, and the sensors 58A, 58B, 58C is schematically illustrated in dashed line. In this manner, data, control signals, messages, or the like can be transmitted between the controller 57, the motor 56, and the sensors 58A, 58B, 58C. It is further contemplated that the controller 57 can be communicatively coupled to other components or devices in the filament winding system 10, such as other measurement devices, user inputs, or the like by way of the communication link 57C.

In the non-limiting exemplary implementation shown, the first sensor 58A and the second sensor 58B can each include an encoder or position sensor coupled to a corresponding pair of guide arms 52 and measuring the filament angle 50F. The third sensor 58C can include a force sensor or a torque sensor and measuring an applied force or applied torque on the pair of guide arms 52. In yet another example, another sensor can be provided such as a counter for sensing or detecting a number of hoop fibers or filaments in the set of filaments 28 passing through the tensioner assembly 50.

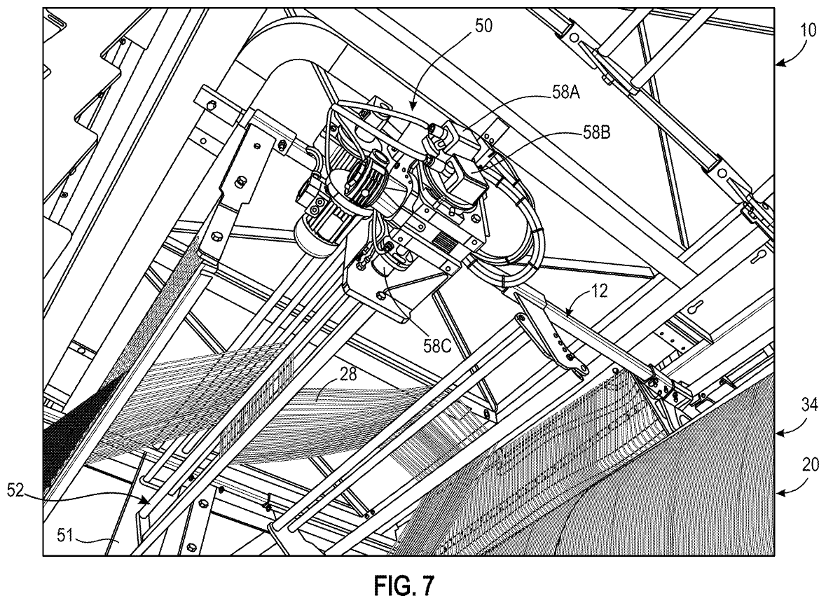

FIG. 7 illustrates the tensioner assembly 50 in the filament winding system 10. Portions of the wrapping system 12 are also illustrated. During operation, the set of filaments 28 are threaded or passed over the pair of guide arms 52. During operation, the controller 57 (FIG. 6) can receive signals, data, or the like from the sensors 58A, 58B, 58C or from the motor 56. Such signals can include any or all of an applied torque on the pair of guide arms 52, a number of fibers passing through the tensioner assembly 50, or the filament angle 50F (FIG. 6) at one or multiple points in time, or the like, in non-limiting examples. The controller 57 can also determine a tensile force present within the set of filaments 28 based on received signals from the sensors 58A, 58B, 58C or from the motor 56. For instance, in one non-limiting example, the controller 57 can determine a current tensile force based on a signal from the first sensor 58A or the second sensor 58B indicative of a current filament angle 50F, where the current filament angle 50F can be mapped, converted, or the like to determine the corresponding tensile force. In another non-limiting example, the controller 57 can determine the current tensile force based on a signal from the third sensor 58C indicative of an applied torque on the pair of guide arms 52, where the applied torque can be mapped, converted, or the like to determine the corresponding tensile force.

The controller 57 can also provide a control signal to the motor 56 to provide or modify the tensile force within the set of filaments 28. For instance, based on the determined tensile force, the controller 57 can controllably operate the motor 56 to regulate the filament angle 50F and provide a predetermined tensile force or modify a tensile force within the set of filaments 28.

In this manner, the tensioner assembly 50 can provide for automatic tension control of the set of filaments 28 during operation of the filament winding system 10. Such automatic tension control can provide for improved product quality and a reduction in raw material consumption.

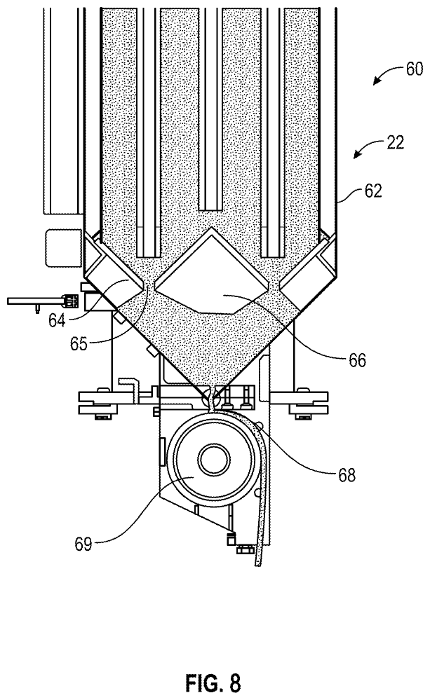

Referring now to FIGS. 8-13, a dosing unit 60 is shown that can be utilized in the filament winding system 10. The dosing unit 60 can at least partially define the supply device 22. The dosing unit 60 can provide portions of material, including granular material, pelletized material, fibrous material, or the like, onto the mandrel 20. In some examples, the dosing unit 60 can be used for dosing sand onto the mandrel 20. Such sand can be optionally prewarmed by a heat source and then portioned, metered, or dosed onto the mandrel 20 for coating the filaments over the mandrel 20. In traditional dosing units, uneven heating can result from sand collecting in a nonuniform distribution prior to dosing, where portions of the sand become overheated while other portions of the sand remain cool or underheated. It can be appreciated that such temperature irregularities in the dosed sand portions can result in surface irregularities, non-uniform component thicknesses, or other undesirable features in the finished component.

In the illustrated example, the improved dosing unit 60 includes a vertical housing 62 with a nonuniform interior wall 64. In the illustrated example, the interior wall 64 can be formed as a bottom wall having a “W-shaped” geometric profile forming multiple outlets 65. The housing 62 can also include a dosing chamber 66 below the interior wall 64 and having a dosing outlet 68. The dosing outlet 68 can be positioned to provide or dose portions of sand onto a dosing roller 69 positioned above the mandrel 20. In some examples, one or more heated plates or other heat sources can be provided within the housing 62 for warming the sand prior to collection on the interior wall 64. During operation, sand (including, optionally, prewarmed sand) can flow downward through the housing 62, collect on the interior wall 64, move into the dosing chamber 66 by the multiple outlets 65, and transfer to the dosing roller 69 before moving out of the housing 62. The irregular shaped, in some examples W-shaped, interior wall 64 with multiple outlets 65 can provide for more even heating of material within the housing 62 and a more uniform distribution of sand provided into the dosing chamber 66. In this manner, the sand can be heated more uniformly and more efficiently without stocking and overheating problems.

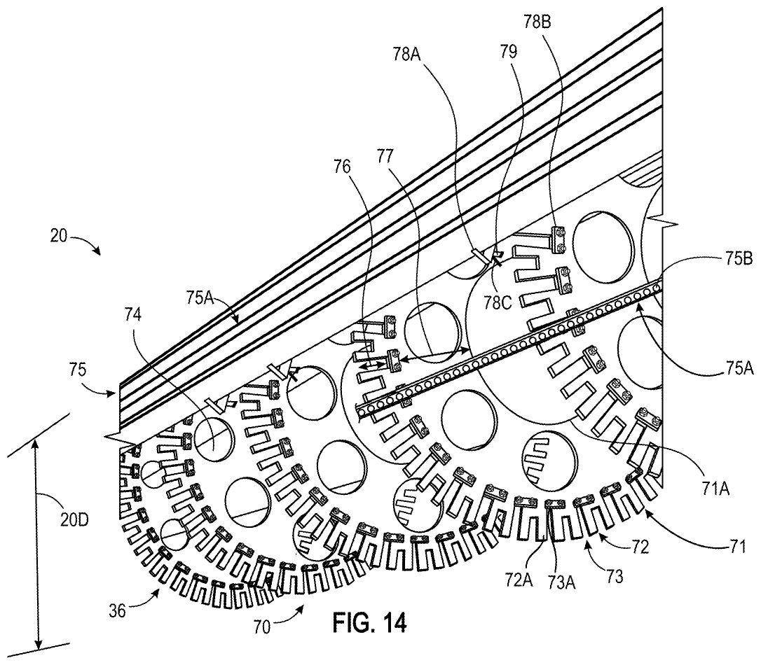

Referring now to FIGS. 14-16, further details of the mandrel assembly 20 are illustrated in accordance with various aspects described herein.

Mandrel assemblies and fastening systems typically include multiple, discrete spacing elements or disks each secured to a central shaft. A set of axially-oriented metallic (e.g. aluminum) beams can be coupled to the spacing disks with a set of fasteners. When changing production on a traditional mandrel assembly from one effective diameter to another effective diameter, such traditional assemblies require stopping production, disassembling of fasteners and spacing elements from the beams, and re-assembly of new spacing elements and fasteners to the beams to form a new effective mandrel diameter. Such a process can be time intensive and labor intensive. Furthermore, such traditional systems often include separate hardware for setting different aspects of the assembled mandrel. For instance, one screw may be utilized for forming a spacing distance between the beam and central shaft, and another screw may be utilized to fix the beam in a set or installed position. In some examples with traditional systems, a single dedicated tool must be utilized for setting all fasteners for the beams, which further prolongs the fastening procedure and results in extended stoppage of part production when a diameter change is performed. In one example of a traditional fastening system, a total of 1,248 screws were used in setting the beam spacing distance and securing the beams to the spacing disks. It is understood that accurate setting of fasteners can be an important factor for part quality in the finished component.

Aspects of the mandrel assembly 20 described herein provide for an improved assembly and fastening system for setting or modifying an effective dimension of the mandrel 20. Aspects of the mandrel assembly 20 described herein also provide for forming articles of multiple sizes by quickly and easily changing an effective size of the mandrel 20.

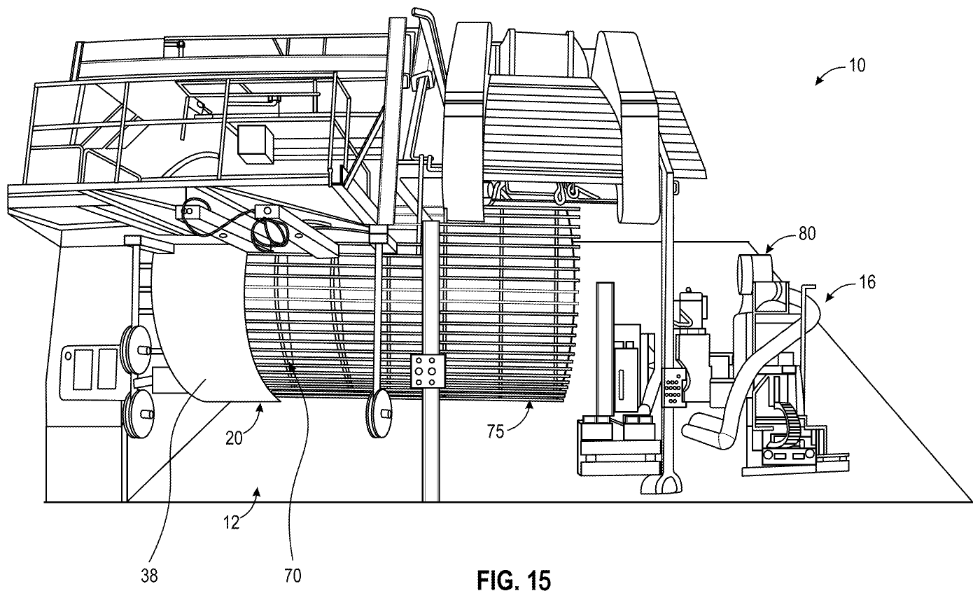

FIG. 14 illustrates the mandrel assembly 20 in isolation. As described earlier, the mandrel 20 can include the band 38 (shown in FIG. 15) wound about the set of spacers 36. In the example shown, the set of spacers 36 can include a set of spacing disks 70 having one or more spacing disks 71. Each spacing disk 71 can include a central aperture 71A. A central shaft 74 can be provided in the mandrel assembly 20 and extend axially through the central apertures 71A as shown.

In addition, each spacing disk 71 can include a set of projecting arms 72 defining a corresponding set of slots 73. More specifically, a single projecting arm 72A in the set of projecting arms 72 can define a single slot 73A in the set of slots 73.

A set of beams 75 can also be provided in the mandrel assembly 20. The set of beams 75 can include metallic beams, such as aluminum beams in a non-limiting example. The set of beams 75 can be arranged circumferentially about the set of spacing disks 70. The set of beams 75 can also extend axially through the corresponding set of slots 73. More specifically, one beam 75A can extend through one slot 73A of each spacing disk 71 in the set of spacing disks 70. In this manner, the one beam 75A can extend axially across multiple spacing disks 71 through corresponding multiple slots 73A thereof.

In the non-limiting example shown, the set of beams 75 can include roller bearings 75B for reduction of friction and smooth sliding motion of the band 38 (FIG. 15) during operation. It is understood that the set of beams 75 can be formed without the illustrated roller bearings, and that other friction reduction mechanisms can be provided for smooth motion of the band 38.

Fasteners can also be provided in the mandrel assembly 20 for coupling of the set of beams 75 to the set of spacing disks 70. A first fastener 78A can be coupled to the one beam 75A. In the example shown, multiple first fasteners 78A are coupled to the one beam 75A. In one exemplary implementation, the first fastener 78A can include a spring-based locking pin 79 that is received within the second fastener 78B.

A second fastener 78B can be coupled to one spacing disk 71 in the set of the spacing disks 70. In the example shown, multiple second fasteners 78B are coupled to the one spacing disk 71. The second fastener 78B can be slidable along the slot 73A in a direction indicated by arrow 76. The second fastener 78B can be secured to the projecting arm 72A once in a desired position. Bolts or screws can be utilized to secure the second fastener 78B to the projecting arm 72A in some non-limiting examples. In this manner, the second fastener 78B can define a spacing distance 77 from the central shaft 74 as shown. It is understood that the spacing distance 77 corresponds to the mandrel diameter 20D, where the mandrel diameter 20D increases as the spacing distance 77 increases.

When assembling the mandrel assembly 20, the set of beams 75 can be secured to the spacing disks 70 by selectively coupling or engaging the first fasteners 78A with the second fasteners 78B. In some examples, the first fastener 78A can be laterally inserted into the second fastener 78B. In an exemplary implementation, a third fastener 78C can be provided for additional securing of the first and second fasteners 78A, 78B after coupling. The third fastener 78C can include a security screw in one non-limiting example. It is contemplated that one beam 75A can include a single third fastener 78C (e.g. a single security screw) securing together a single first fastener 78A and a single second fasteners 78B for the entire one beam 75A to be fixedly secured in the mandrel assembly 20 in a desired size configuration. For instance, in one non-limiting example, the mandrel assembly 20 can be assembled having a desired mandrel diameter 20D using a total of seventy-eight beams 75 and corresponding seventy-eight third fasteners 78C.

When adjusting the mandrel diameter 20D of the mandrel assembly 20, the first fasteners 78A can be decoupled from the corresponding second fasteners 78B. It is contemplated that the first fasteners 78A can remain coupled to the set of beams 75 without need of disassembly. The second fasteners 78B can each be moved to a new position within the slots 73A having a different spacing distance 77. In this manner, the second fasteners 78B can define a variable spacing distance 77 from the central shaft 74. The set of beams 75 can be re-assembled by way of the first fasteners 78A rejoining to the corresponding second fasteners 78B and optionally secured with third fasteners 78C as described above. In this manner, the set of beams 75 can define a variable mandrel diameter 20D based on the variable spacing distance 77.

It can be appreciated that aspects of the described mandrel assembly 20 can provide for significant time reduction and improvements in process efficiencies when changing from production of one component size to another, e.g. production of hollow pipes having different diameters. The total time for a mandrel effective diameter change can be reduced, including by approximately 40% in some examples. The mandrel assembly 20 can also be accomplished with fewer workers compared to traditional mandrel assemblies. In one example, three workers can be used to complete a diameter change in the mandrel assembly 20, compared to four or more workers needed for a traditional mandrel assembly in a comparable time.

Referring now to FIG. 15, a side view of the filament winding system 10 is illustrated with a portion of the wrapping system 12 and the cutting system 16. The mandrel assembly 20 is shown in an assembled configuration. In the example shown, a portion of the band 38 is arranged over the set of spacing disks 70 and the set of beams 75. In addition, a cutting assembly 80 is illustrated in the filament winding system 10 in accordance with various aspects described herein. The cutting assembly 80 can at least partially define the cutting system 16.

Traditional cutting devices (e.g. pipe cutting devices) are generally known to operate under constant rotation of the cutting disk while the cutting disk is progressed into the pipe. In some examples, the pipe undergoes rotational motion about a central axis, as well as axial motion along a production line. The combined movements of the cutting disk and pipe can lead to axial progression of the cut along the pipe, thereby forming a helical cut through the pipe.

In addition, in traditional cutting devices, cutting parameters are typically fixed at a constant value without monitoring or control of cutting disk parameters. In some examples, the cutting disk can undergo undesirable loading or wear due to the fixed, non-controlled cutting disk operation. Such traditional cutting devices can introduce undesirable surface features or cutting motions, such as on an inner layer or liner of the pipe. Additionally, in some examples, cutting parameters for the cutting disk may require customization for each type of pipe based on pipe dimensions, materials, and cutting disk or cutting disk conditions.

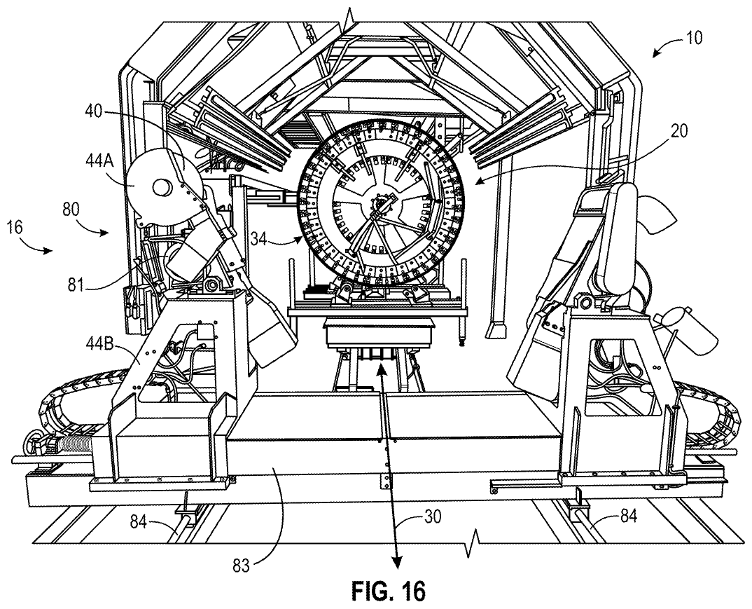

Turning to FIG. 16, the mandrel assembly 20, component 34, and the cutting assembly 80 are shown along an axial view. The cutting assembly 80 can include a housing 44A carrying the cutting disk 40 and coupled to a base 44B. The housing 44A can be pivotally mounted to the base 44B as shown. A movable carriage 83, such as a movable platform, rail system, or other mobility component, can also be provided in the cutting assembly 80. The housing 44A and base 44B can be mounted to the carriage 83, providing for movement of the cutting disk 40 along the axial direction 30. In a non-limiting example, rails 84 can be provided for axial sliding motion of the carriage 83 though this need not be the case.

A motor 81 can be provided for driving rotation of the cutting disk 40. The motor 81 can be similar to the motor 56 (FIG. 6). The motor 81 can include an asynchronous electric motor in one non-limiting example. One or more pneumatic cylinders 82 can be operably coupled to the housing 44A for advancement, pivoting, or other motion of the cutting disk 40. For instance, variation of fluid pressure within the pneumatic cylinders 82 can cause a corresponding motion of the cutting disk 40.

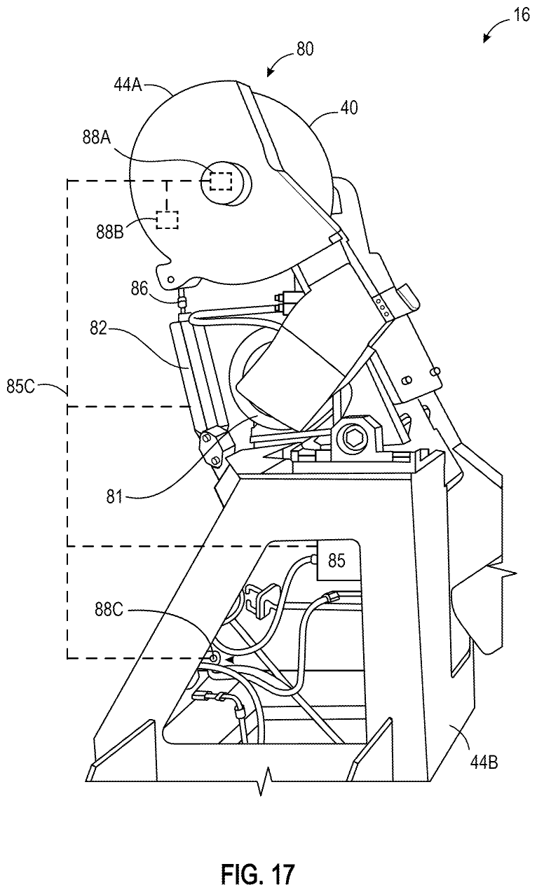

FIG. 17 illustrates further details of the cutting assembly 80. Each pneumatic cylinder 82 can have a corresponding actuator 86 coupled to the housing 44A as shown. In this manner, operation of the pneumatic cylinder 82 can cause motion of the actuator 86 and corresponding movement of the housing 44A, such as for rotation, cutting disk advancement, or the like as described above. In the illustrated example one pneumatic cylinder 82 and actuator 86 is indicated, however any number can be provided including two or more.

A controller 85 similar to the controller 57 (FIG. 6) can be provided in the cutting assembly 80. The controller 85 can include a processor and a memory. In the example shown, the controller 85 is schematically illustrated as being coupled to a lower portion of the cutting disk 40 though this need not be the case. The controller 85 can be located at any suitable location, including being positioned remotely from the cutting assembly 80.

One or more sensors can also be provided in the cutting assembly 80. In the illustrated example, a first sensor 88A, a second sensor 88B, and a third sensor 88C are shown, although any number of sensors can be provided. The first sensor 88A can be configured to sense or detect an electric current of the motor 81 indicative of a load on the motor 81 driving the cutting disk 40. The second sensor 88B can be configured to sense or detect a cutting depth, cutting progression, or the like of the cutting disk 40 during operation. In one non-limiting example, the second sensor 88B can include a wire encoder. While the first and second sensors 88A, 88B are schematically illustrated as being coupled to the housing 44A, this need not be the case. The sensors 88A, 88B can be positioned at any suitable location in the cutting assembly 80, including being positioned remotely from the cutting disk 40.

In addition, the third sensor 88C can be configured to sense or detect a position of the cutting disk 40 along the axial direction 30. For instance, in one non-limiting example the third sensor 88C can include an encoder. In another non-limiting example, the third sensor 88C can be in the form of a servo motor wherein control or operation of the servo motor corresponds to an axial position of the cutting disk 40. While the third sensor 88C is schematically illustrated as being located beneath the cutting disk 40, this need not be the case and the third sensor 88C can be positioned at any suitable location.

The controller 85 can be communicatively coupled to any or all of the motor 81, the one or more pneumatic cylinders 82, and the sensors 88A, 88B, 88C. A communication link 85C (shown in dashed line) illustrates that can be provided for communicative coupling of the controller 85, the motor 81, the pneumatic cylinders 82, and the sensors 88A, 88B, 88C. In this manner, data, control signals, messages, or the like can be transmitted between the controller 85, the motor 81, the pneumatic cylinders 82, and the sensors 88A, 88B, 88C. It is further contemplated that the controller 85 can be communicatively coupled to other components or devices, such as the controller 57 (FIG. 6), other measurement devices, user inputs, or the like, by way of the communication link 85C.

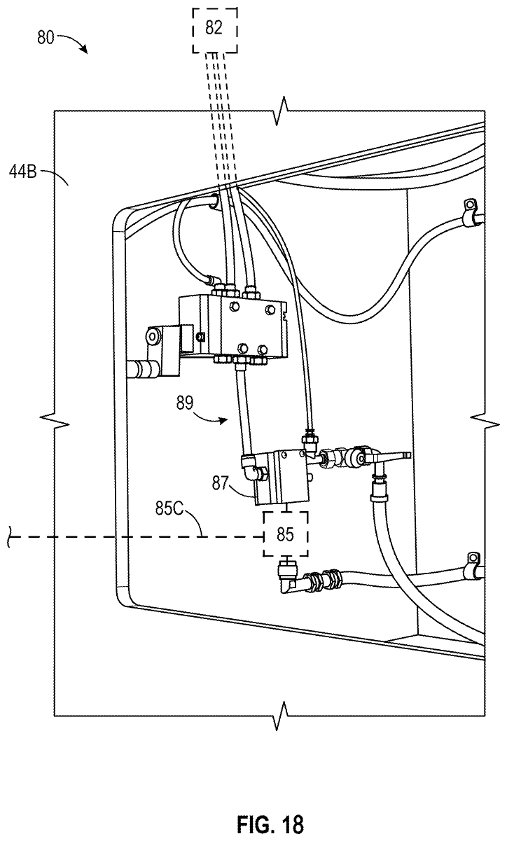

FIG. 18 illustrates further details of the controller 85. It is contemplated that the controller 85 can actively control a pressure in the one or more pneumatic cylinders 82. In one non-limiting example a controllable valve 87, such as a proportional valve, can be operably coupled to the controller 85 by way of the communication link 85C. A set of fluid lines 89 can fluidly couple the controllable valve 87 to the one or more pneumatic cylinders 82.

The controller 85 can receive operation parameters of the cutting assembly 80 by way of the communication link 85C and controllably operate the valve 87 to actuate the housing 44A, thereby controlling motion of the cutting disk 40 based on the received operation parameters. It is understood that such controllable operation of the pneumatic cylinders 82 (e.g. controllable operation of pressure within the pneumatic cylinders 82) can correspond to controlling an advancing motion of the cutting disk 40 into the component 34, a retreating motion of the cutting disk 40 from the component 34 (FIG. 16), or an amount of pushing force or pulling force of the cutting disk 40 during advancing or retreating motion.

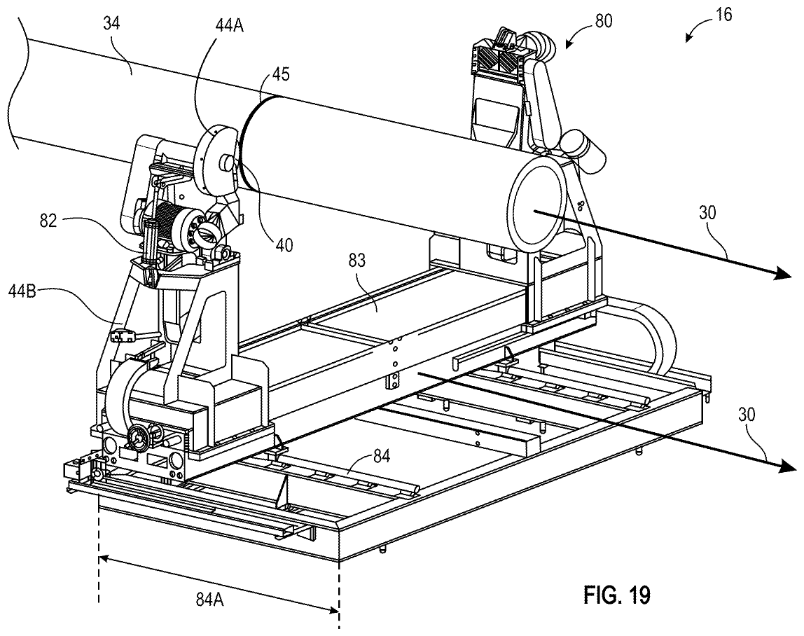

FIG. 19 illustrates the cutting assembly 80 in operation. As the component 34 is advanced by the mandrel assembly 20 (FIG. 16) along the axial direction 30, the carriage 83 can move simultaneously with the component 34 along the axial direction 30 while the controller 85 operates the pneumatic cylinder 82 and actuator 86 (FIG. 17). The actuator 86 can drive motion of the housing 44A at least along a direction toward the component 34, thereby advancing the cutting disk 40 into the component 34 and forming a cut 45 as shown. Such co-axial motion of the carriage 83 can provide for the cutting disk 40 forming the cut 45 symmetrically through the component 34, i.e. without forming helical cuts through the component 34.

In addition, during operation, the controller 85 can receive signals from the communication link 85C, including from any or all of the sensors 88A, 88B, 88C, or the motor 81, regarding operating parameters of the cutting assembly 80. Such operating parameters can include any or all of a load on the motor 81, a current axial position of the cutting disk 40, a current depth of the cut 45 through the component 34, a circumferential extent of the cut 45, an axial extent of the cut 45, or an axial position of the cutting disk 40, in non-limiting examples. The controller 85 can determine additional operating parameters based on received signals from the communication link 85C. In one non-limiting example, the controller 85 can determine an axial speed of the cutting disk 40 based on received periodic signals from the third sensor 88C regarding an axial position of the cutting disk 40. In another non-limiting example, the controller 85 can determine a time needed to complete the cut 45 based at least on received signals from the second sensor 88B regarding a cutting depth or progression through the component 34.

Some exemplary operations will be described below for the cutting assembly 80. It is understood that such operations can be performed during a single cutting operation or during multiple cutting operations, and that aspects of the described operations can be used in combination with one another as desired. The described operations are illustrative of exemplary aspects of the cutting assembly 80 and do not limit the disclosure in any way.

In one example of operation, an axial distance interval 84A can be defined along the axial direction 30. The axial distance interval 84A can represent a maximum available traveling distance for the carriage 83, or a cutting operation distance for the carriage 83, in non-limiting examples. For instance, the controller 85 can controllably operate the cutting disk 40 to begin the cut 45 at the start of the axial distance interval 84A and complete the cut 45 at the end of the axial distance interval 84A.

In another example of operation, the controller 85 can perform a comparison or other computation relating to a cutting time duration corresponding to a complete cutting operation, an available time duration for completing a desired cutting operation including based on pipe position, an estimated completion time for an in-progress cutting operation, or the like, or combinations thereof. The controller 85 can also provide an output signal or indication, such as for a visual display, relating to the comparison or computation. For instance, in one example the controller 85 can provide an alert if a cutting operation cannot be completed in an available time over the axial distance interval 84A. Such an available time can be determined based on any or all of a thickness of the component 34, an axial speed of the component 34, a length of the axial distance interval 84A, or the like.

In another example of operation, the controller 85 can controllably operate the motor 81 and pneumatic cylinder(s) 82 to drive rotation or movement of the cutting disk 40 while providing a constant amount of loading, an optimized level of loading, or the like. In this manner, the controller 85 can controllably operate at least one of the motor 81 or the pneumatic cylinder 82 based on a load on the motor 81.

In still another example of operation, the controller 85 can modify cutting parameters of the cutting assembly 80 based on signals received from the communication link 85C, including the sensors 88A, 88B, 88C. In some examples, the controller 85 can automatically adapt cutting parameters, monitor a cutting process, or provide an indication (e.g. an audio or visual alert) that the component 34 can be cut within an available time, based at least partially on signals received from the sensors 88A, 88B, 88C.

The described aspects of the cutting assembly 80 can provide for improved operations efficiency as well as preventing undesirable cutting or surface artifacts on the component 34 (including on the inner layer of the component 34). Aspects of the cutting assembly 80 additionally provide for reduction or prevention of undesirable loading of the cutting disk during operation, as well as user indication of operative parameters including cutting assembly status or wear.

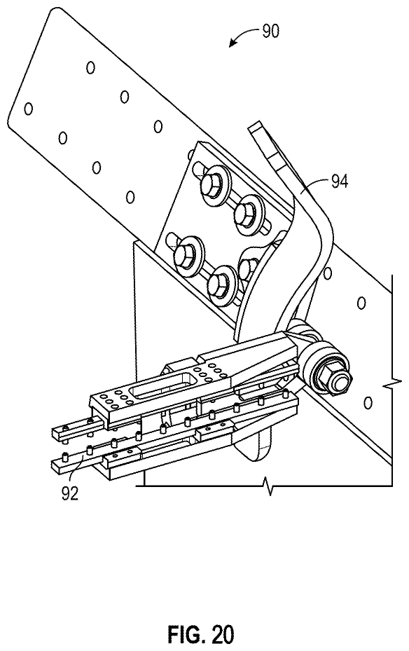

Referring now to FIGS. 20-23, an improved guiding assembly 90 is illustrated that can be used for sliding, moving, or otherwise returning an axial position of the band 38 (e.g. a metal band) along the set of beams 75 of the mandrel assembly 20.

Traditional guiding assemblies typically include steel band pushers with sliding plates made of softer material and attached to aluminum beams. Side plates can be mounted on the steel band pushers. Returning guides are usually constructed from welded metal plates. The steel band pusher can travel along the returning guide to return the steel band to a starting position, e.g. at one end of the mandrel. Traditional guiding assemblies can often experience material wear of sliding elements, and the pusher can occasionally stick in position during a desired motion along the guide. The side plates of traditional guiding assemblies can also open or change relative position in an undesirable manner during operation, e.g. a twisting motion due to friction between bearings. Such traditional assemblies can also be noisy during operation due to motion of bearings against metal plates of the return guide.

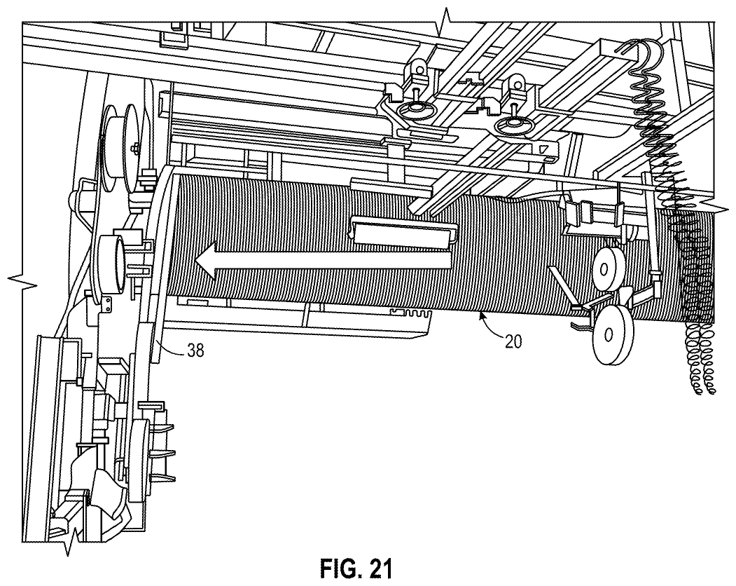

In the illustrated example, a guiding assembly 90 is shown that can be utilized in the filament winding system 10. The guiding assembly can include linear guides 92 that provide for linear movement of the pushers, with more precise guided motion of the pusher in all directions, without sticking during motion. The guiding assembly 90 can also include a curved returning guide 94. The guiding assembly 90 can further include an increased number of bearings compared to traditional guiding assemblies. During operation, the band 38 can be returned to a starting position on the mandrel 20 as shown by an arrow in FIG. 21. The curved returning guide 94 can provide softer contact and guiding of the band 38 during a return operation. The increased number of bearings can provide for a reduction in noise level as well as a reduction in applied load on the linear guides 92 and component wear of the cam plate.

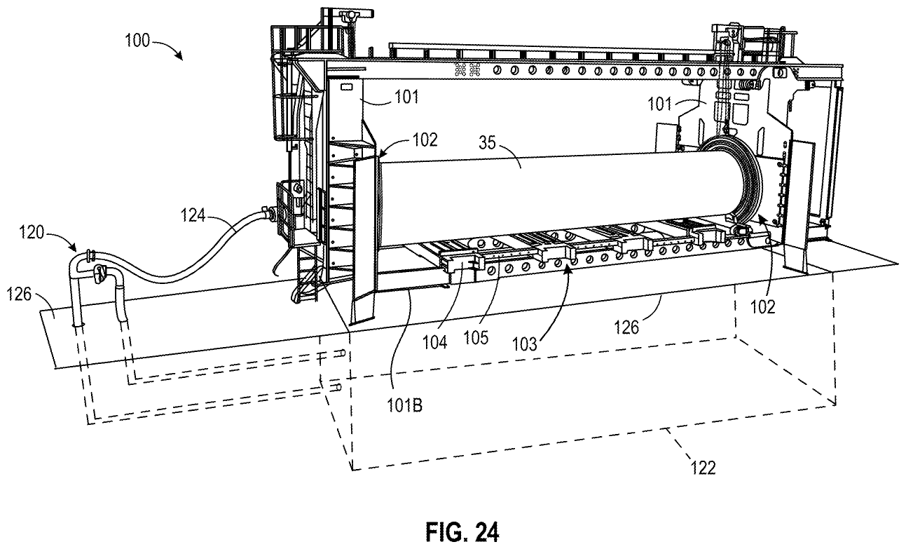

Referring now to FIGS. 24-27, a hydrostatic pressure testing system 100 (also referred to herein as “hydro testing system 100”) that can be utilized with the filament winding system 10 is illustrated in accordance with various aspects described herein. The hydro testing system 100 can be utilized for testing of static fluid pressure testing, fluid sealing, or the like within a hollow component (e.g. pipe) produced in the filament winding system 10.

Hydro testing devices typically include sealing end plates that cover each end of the pipe for fluid sealing. Such end plates are positioned at a predetermined distance from one another and fixed in place over a larger tank containing a lifting mechanism. In traditional hydro testing devices, the pipe is raised by the lifting mechanism into a testing position between the sealing end plates. Such traditional hydro testing devices generally have lifting mechanisms with multiple, high-load lifting tables for supporting the pipe during lifting into the testing position. The pipe lifting process itself can be time-consuming, and additional adjustments of the pipe for alignment or correcting of positioning errors are needed at each end of the pipe. Testing of large pipes typically includes adding manually-positioned supports in combination with the lifting mechanism for supporting the weight of the pipe. In addition, traditional hydro testing devices do not allow for covering the pool or tank with panels, grates, or the like due to the presence of lifting tables within the pool.

Turning to FIG. 24, a perspective view is shown of the hydro testing system 100 in accordance with various aspects described herein. The component 34 (FIG. 2) is shown in the form of a hollow pipe 35 arranged in a testing position in the hydro testing system 100.

The hydro testing system 100 can include an outer frame 101 defining a base 101B, one or more sealing covers 102 for covering the open ends of the pipe 35, and a support mechanism 103 coupled to the base 101B and positioned between the sealing covers 102 for supporting the pipe 35 as shown. In the non-limiting example shown, the support mechanism 103 includes multiple spaced platforms 104 that are slidable along connecting beams 105 extending along side edges of the base 101B. It is understood that the support mechanism 103 can include any suitable mechanism for supporting the pipe 35, including a flat or contoured platform in another non-limiting example.

Each sealing cover 102 can include an end plate 110 coupled to the outer frame 101 and carrying an end seal 112. Each end plate 110 can be movable at least vertically with respect to the outer frame 101. For instance, the end plates 110 can be moved by a hydraulic lift or a crane in non-limiting examples. Each end seal 112 can receive an open end of the pipe 35, thereby securing and fluidly sealing the pipe 35 within the outer frame 101.

A fluid supply system 120 including a supply tank 122 and one or more fluid lines 124 can also be provided in the hydro testing system 100. The supply tank 122 can store fluid, such as water in one example, which can be supplied by the fluid lines 124 to the inside of the pipe 35 for hydrostatic testing. The fluid lines 124 can also provide for liquid circulation between the supply tank 122 and the pipe 35 during a testing operation. In one exemplary implementation, the one or more fluid lines 124 can be integrated with the sealing cover 102 as a single, unitary assembly.

The supply tank 122 can be in the form of an underground tank and include a cover 126. For instance, the cover 126 can include one or more panels or grills covering over the supply tank 122, providing for improved safety during testing. In this manner, the supply tank 122 can be suitably isolated from other portions of the hydro testing system 100 by way of the cover 126.

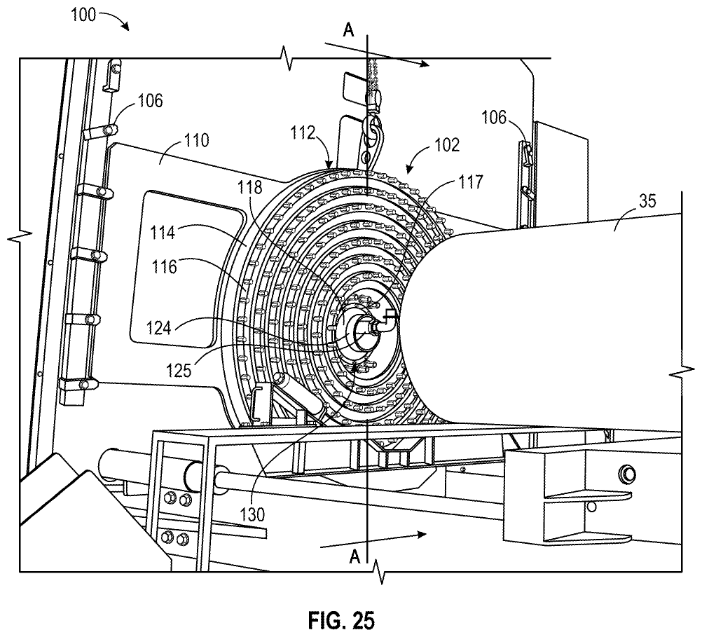

Referring now to FIG. 25, the pipe 35 is illustrated in position on the support mechanism 103, and one end seal 112 is shown prior to receiving an end of the pipe 35. In the non-limiting example shown, a lifting device such as a crane is coupled directly to the end seal 112 by way of a hook, whereby the end seal 112 and end plate 110 can be lifted together as a unit for alignment with the pipe 35. Once each sealing cover 102 is brought into a desired position, clamps 106 can be used to secure the end plate 110 to the outer frame 101, thereby affixing each sealing cover 102 to the corresponding end of the pipe 35.

The sealing cover 102 can include an aperture 117 in the end plate 110 through which the fluid line 124 extends, as well as a gasket 118 for fluid sealing around the fluid line 124. In a non-limiting example the gasket 118 can include a rubber-flap gasket. A set of fasteners 130 can secure the fluid line 124 to the sealing cover 102 and gasket 118 as shown.

In addition, a ventilation pipe 125 can be provided extending coaxially through at least a portion of the fluid line 124. When the pipe 35 is coupled to the sealing cover 102, the ventilation pipe 125 can extend into the interior of the pipe 35.

The end seal 112 also includes multiple concentrically-arranged projections 114 forming corresponding multiple concentrically-arranged sealing channels 116. The sealing channels 116 can have varying diameters corresponding to multiple sizes of hollow component ends. In this manner, a single sealing cover 102 can accommodate multiple pipe sizes for testing.

It is contemplated that the fluid line 124, ventilation pipe 125, and the set of fasteners 130 can at least partially define a fast change system for the hydro testing system 100. The set of fasteners 130 can form an independent coupling or mounting between the sealing cover 102 and the fluid line 124. In this manner, the sealing covers 102 can be independently removed or replaced without need of adjusting or disassembling the fluid line 124.

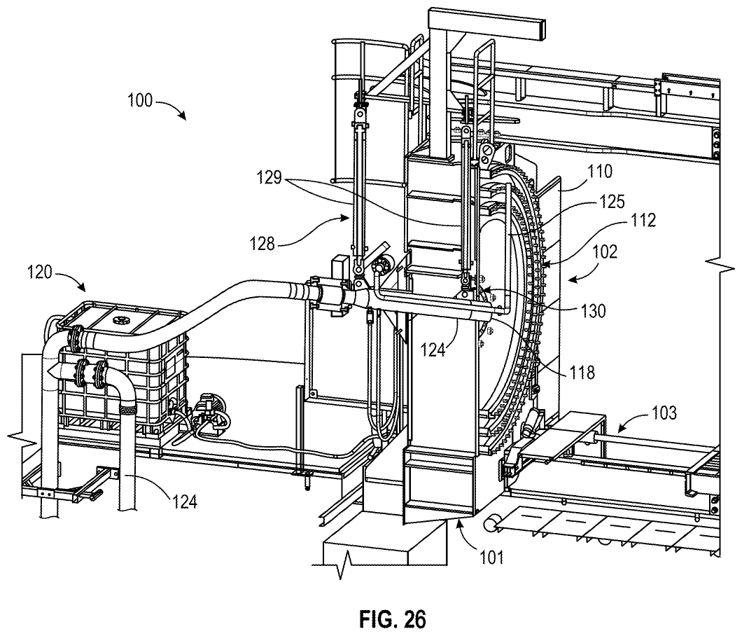

Turning to FIG. 26, a partial cross-sectional view is shown along line A-A of FIG. 25 and illustrating interior portions of the hydro testing system 100. The fluid line 124 extends through the outer frame 101 and gasket 118 of the end seal 112. The ventilation pipe 125 extends through the fluid line 124 and then upward for positioning within the pipe interior.

It is also contemplated that the fluid lines 124 can be flexible or co-movable with the sealing covers 102. For instance, a lifting assembly 128 can be provided for movement of portions of the fluid supply system 120 as the end seals 112 are moved. In the illustrated example, the lifting assembly 128 includes hydraulic lifting cylinders 129 coupled to the fluid line 124 though this need not be the case. It is contemplated that the lifting assembly 128 can include any or all of a manual lifting assembly such as a manual spindle, or an electric lifting assembly such as an electric jack or winch, or a crane lift, in non-limiting examples. In this manner, the lifting assembly 128 can provide for co-movement of the fluid line 124 with the end seal 112.

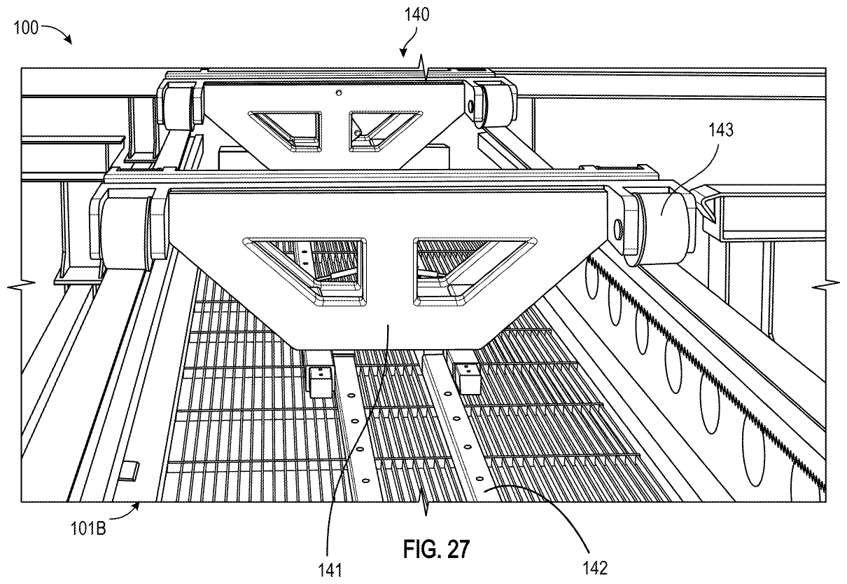

Referring now to FIG. 27, another support mechanism 140 is shown that can be utilized in the hydro testing system 100. The support mechanism 140 is similar to the support mechanism 103 (FIG. 24).

In the illustrated example, the support mechanism 140 includes multiple platforms 141 similar to the platforms 104 (FIG. 24) that are slidable along connecting beams 142 similar to the connecting beams 105 (FIG. 24). One difference compared to the support mechanism 103 is that the connecting beams 142 are located along a bottom surface of the base 101B. Another difference is that the platforms 141 include rollers 143 that are aligned with side edges of the base 101B. The rollers 143 provide for smooth motion of the platforms 141 along the base 101B during position adjustment along the connecting beams 142. In this manner, the support mechanism 140 can support the pipe 35 in a stationary position between the sealing covers 102 (FIG. 25), providing for adjustments of the sealing covers 102 with respect to the pipe 35.

During operation, the pipe 35 can be arranged in position between the sealing covers 102 and supported by the support mechanisms 103, 140. The sealing covers 102 can be moved, such as being raised or lowered, until each end seal 112 is aligned or in registry with the corresponding end of the pipe 35 as shown in FIG. 25. Fluid lines 124 of the fluid supply system 120 can also be raised or lowered with the sealing covers 102, such as by the lifting assembly 128 as shown in FIG. 26. Once in alignment, the clamps 106 can secure the end plates 110 in a fixed position with respect to the outer frame 101. The fluid supply system 120 can supply liquid to the interior of the pipe 35 for a hydrostatic testing procedure.

Aspects of the hydro testing system 100 described herein provide for a significant reduction in time for assembly and pressure testing. Movement of the sealing covers 102 with respect to the stationary pipe 35 provides for a faster and more accurate assembly compared to traditional systems where the pipe ends are moved into alignment with stationary end seals. The fast change system described herein additionally provides for ease of adjusting the end seals of the hydro testing system 100 to accommodate pipes of varying sizes while preventing unnecessary disassembly of other components such as the fluid supply system 120. Aspects further provide for a reduction in a number of operators needed for the testing procedure as compared to traditional hydrostatic testing devices.

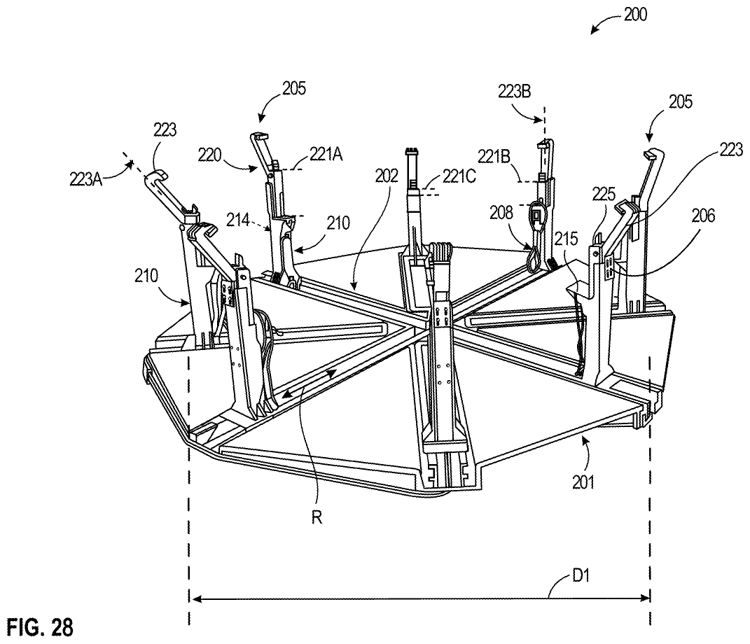

Referring now to FIG. 28, a sleeve hydrostatic pressure testing system 200 (or “sleeve hydro testing system 200”) that can be utilized in the filament winding system 10 is illustrated in accordance with various aspects described herein. The sleeve hydro testing system 200 can be utilized for statis fluid pressure testing, fluid sealing, or the like within a hollow component (e.g. pipe) produced in the filament winding system 10 and forming a sleeve.

Traditional sleeve hydro testing machines generally include a two-part sealing ring or a device configured to move the sealing ring in the tested sleeve. In such traditional machines, a dedicated component is used for centering the sleeves with the sealing rings which can increase the overall size of the testing machine. Such traditional machines also use additional locking devices to lock the sleeves or extract the sleeves. In addition, sleeves may be blocked in such machines for operations such as gasket soaping or visual monitoring of the sleeves during testing.

In the exemplary implementation shown, the sleeve hydro testing system 200 includes a platform 201 and a radially-extending set of rails 202. Multiple fitting arms 205 can be coupled to the set of rails 202. While eight fitting arms 205 are illustrated, any number of fitting arms 205 can be provided.

The fitting arms 205 can also be slidably coupled to the corresponding set of rails 202, where each fitting arm 205 can be movable along a direction R indicated with an arrow. In the example shown, the sleeve hydro testing system 200 is in a first configuration wherein the fitting arms 205 are arranged circumferentially about the platform 201 to define a first assembly diameter D1.

Each fitting arm 205 can include a base assembly 210 and an arm assembly 220. The base assembly 210 can define an interior 214, such a hollow region extending partially or fully to the platform 201. The arm assembly 220 can be at least partially disposed within the interior 214.

The base assembly 210 and the arm assembly 220 can include a respective base ledge 215 and arm ledge 225 as shown. The arm ledge 225 can be positioned above the base ledge 215. In addition, the arm ledge 225 can be positioned radially outward of the base ledge 215 with respect to the platform 201. In this manner, the base ledges 215 can collectively support a smaller-diameter sealing ring, and the arm ledges 225 can collectively support a larger-diameter sleeve in registry with the sealing ring.

The arm assembly 220 can include an arm 221 and a rotatable cap 223 pivotally coupled to the arm 221. The cap 223 can have a C-shaped body as shown. The cap 223 can define an open position 223A forming an opening angle with respect to the arm 221, and a closed position 223B wherein the rotatable cap 223 is aligned with the arm 221. It is contemplated that the rotatable cap 223 can be biased toward the open position 223A in one exemplary implementation.

The arm assembly 220 can also be slidably or telescopically received within the base assembly 210. In the example shown, the arm assembly 220 is movable with respect to the base assembly 210 between an extended position 221A, a lowered position 221B, and a retracted position 221B with respect to the base assembly 210. The extended, lowered, and retracted positions 221A, 221B, 221C are illustrated in dashed line between the movable arm ledge 225 and stationary base ledge 215 though this need not be the case.

In addition, a guide plate 206 can be provided and coupled to the base assembly 210. The guide plate 206 can engage the rotatable cap 223. It is understood that the guide plate 206 can move the rotatable cap 223 from the open position 223A toward the closed position 223B when the arm 221 is moved from the extended position 221A toward the retracted position 221B.

At least one hydraulic actuator 208 can also be provided in the sleeve hydro testing system 200. The hydraulic actuator 208 can include a pump and a set of fluid lines coupled to the multiple fitting arms 205. It is contemplated that the hydraulic actuator 208 can be operably coupled to the arm assembly 220 for movement between the extended position 221A and the retracted position 221C. In one non-limiting example, motion of the arm assemblies 220 can be synchronized by means of one or more flow dividers, one or more hydraulic pumps, and a cross-positioned hydraulic pipeline.

During one non-limiting example of operation, the arm assembly 220 can initially be in the extended position 221A whereby the rotatable cap 223 is in the open position 223A. The arm assembly 220 can then be lowered into the base assembly 210, such as by the hydraulic actuator 208 in one example. As the arm assembly 220 is lowered, the guide plate 206 can urge rotation of the rotatable cap 223 with respect to the arm 221 toward the closed position 223B. When the arm assembly 220 reaches the lowered position 221C, the cap 223 can reach the closed position 223B. In this manner, the lowered position 221C can define a transition between the open and closed positions 223A, 223B.

As the arm assembly 220 is additionally moved from the lowered position 221B toward the retracted position 221C, the cap 223 can remain in the closed position 223B. In this manner, the cap 223 can move at least partially into the interior 214 of the base assembly 210 along with the arm 221. It is contemplated that the arm assemblies 220 can be moved from the extended position 221A to the retracted position 221C by an automatic process, such as by an operator pressing a start button located remotely from the arm assemblies 220 to operate the hydraulic actuator 208 in a non-limiting example.

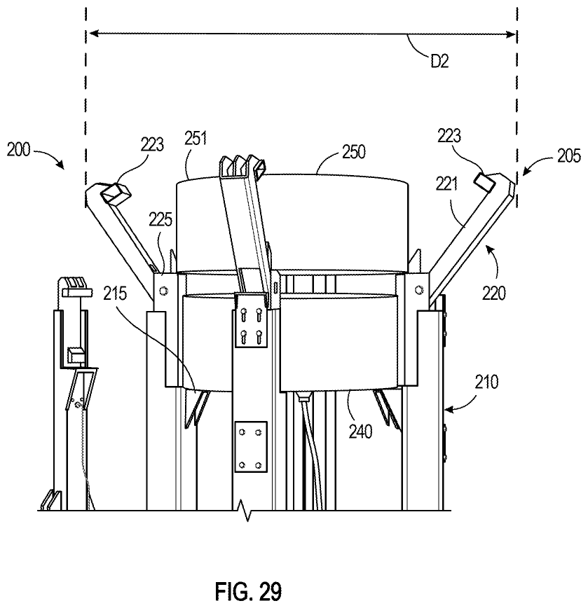

FIG. 29 illustrates the sleeve hydro testing system 200 in a second configuration, wherein four fitting arms 205 are moved toward the center of the platform 201 (FIG. 28) to define a second assembly diameter D2 smaller than the first assembly diameter D1, such as for small-diameter sleeve coupling. It is understood that any number of the multiple fitting arms 205 can be arranged about the platform 201 (FIG. 28) to form any suitable assembly diameter corresponding to a desired size of hollow pipe or sleeve for testing.

A sealing ring 240 and hollow sleeve 250 are also shown in the illustrated example. The hollow sleeve 250 can have a slightly larger diameter compared to the sealing ring 240 for the tested sleeve coupling. The sealing ring 240 can be positioned on the base ledges 215, and the sleeve 250 can be positioned on the arm ledges 225 such that the sleeve 250 is in registry with the sealing ring 240.

During operation, in one exemplary implementation, an operator can control the arm assemblies 220 to move from the extended position 221A toward the closed position 221B (FIG. 28), whereby the caps 223 rotate to a vertical orientation in the closed position 223B (FIG. 28). The caps 223 can engage a top surface 251 of the sleeve 250. Additional downward motion of the arm assemblies 220 toward the retracted position 221B (FIG. 28) causes the caps 223 to press downward on the sleeve 250, thereby fitting the sleeve 250 onto the sealing ring 240 and forming a leak-proof seal between the two components. In this manner, the rotatable cap 223 can be configured to press the hollow sleeve 250 over the inner sealing ring 240 in a sleeve-fit arrangement.

Sealing performance of the sealing ring 240 and sleeve 250 can be tested while the arm assemblies 220 are in the retracted position 221C (FIG. 28). For example, it is contemplated that liquid piping, hoses, or the like can be coupled to the sealing ring 240 for supplying liquid during a hydrostatic pressure testing procedure.

The described aspects of the improved sleeve hydro testing system 200 include improvements in safety, reduction in time needed for testing or adjustment, and a reduction in a number of workers needed to complete a testing process.

To the extent not already described, the different features and structures of the various embodiments can be used in combination with each other as desired, or can be used separately. That one feature may not be illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

What is claimed is:

1. A pressure testing system for a hollow component having an open end, comprising:
an outer frame defining a base;
a support mechanism coupled to the base and comprising at least one movable platform for supporting the hollow component within the outer frame;
a fluid supply system comprising a supply tank fluidly coupled to a fluid line; and
a sealing cover coupled to the outer frame and comprising an end seal for receiving the open end of the hollow component, and also comprising an aperture through which the fluid line extends;
wherein the sealing cover is movable at least vertically with respect to the outer frame for alignment of the sealing cover with the open end of the hollow component.

2. The pressure testing system of claim 1, further comprising a second sealing cover comprising a second end seal and movable with respect to the outer frame for alignment of the second end seal with a second open end of the hollow component.

3. The pressure testing system of claim 1, further comprising a lifting assembly coupled to the fluid line, wherein the fluid line is movable with the sealing cover.

4. The pressure testing system of claim 3, wherein the lifting assembly comprises a hydraulic lifting cylinder.

5. The pressure testing system of claim 1, wherein the end seal comprises multiple concentrically-arranged sealing channels corresponding to multiple sizes of hollow component ends.

6. The pressure testing system of claim 1, further comprising a ventilation pipe extending coaxially within the fluid line and through the aperture in the sealing cover.

7. The pressure testing system of claim 6, further comprising a set of fasteners coupling the fluid line to the sealing cover and arranged about the aperture.

8. The pressure testing system of claim 1, further comprising at least one connecting beam extending along the base and coupled to the at least one movable platform.

9. The pressure testing system of claim 8, wherein the at least one connecting beam is arranged along one of a side edge or a bottom surface of the base.

10. The pressure testing system of claim 8, further comprising a roller coupled to the at least one movable platform and positioned along a side edge of the base.

11. A pressure testing system for a hollow sleeve and an inner sealing ring, comprising:
a platform; and
multiple fitting arms coupled to the platform, with each fitting arm in the multiple fitting arms comprising:
a base assembly defining an interior and comprising a base ledge for supporting the inner sealing ring; and
an arm assembly disposed at least partially within the interior and comprising:
an arm comprising an arm ledge for supporting the inner sealing ring in registry with the hollow sleeve; and
a rotatable cap pivotally coupled to the arm and defining least an open position and a closed position, wherein the rotatable cap is configured to engage a top surface of the hollow sleeve when in the closed position.

12. The pressure testing system of claim 11, wherein the arm assembly is slidably coupled to the base assembly and movable between an extended position and a retracted position with respect to the base assembly.

13. The pressure testing system of claim 12, wherein the arm assembly further defines a lowered position between the extended position and the retracted position, with the lowered position defining a transition between the open position and the closed position of the rotatable cap.

14. The pressure testing system of claim 13, wherein the rotatable cap remains in the closed position when the arm assembly is between the retracted position and the lowered position.

15. The pressure testing system of claim 14, wherein the rotatable cap is configured to press the hollow sleeve over the inner sealing ring in a sleeve-fit arrangement during movement of the arm assembly from the lowered position toward the retracted position.

16. The pressure testing system of claim 12, further comprising a hydraulic actuator operably coupled to the arm assembly for movement between the extended position and the retracted position.

17. The pressure testing system of claim 16, further comprising a guide plate coupled to the base assembly and engaging the rotatable cap during movement of the arm assembly from the extended position toward the retracted position, thereby moving the rotatable cap from the open position toward the closed position.

18. The pressure testing system of claim 11, wherein the rotatable cap comprises a C-shaped body.

19. The pressure testing system of claim 11, further comprising a radially-extending set of rails along the platform, with each fitting arm in the multiple fitting arms slidably coupled to a corresponding rail in set of rails.

20. The pressure testing system of claim 19, wherein each fitting arm in the multiple fitting arms is independently slidable along the corresponding rail in the set of rails.
